(19) United States
(12) Patent Application Publication
(10) Pub. No.: US 2022/0324093 A1
(43) Pub. Date: Oct. 13, 2022

(54) TOOL STORAGE SYSTEM

(71) Applicant: TECHTRONIC CORDLESS GP, Anderson, SC (US)

(72) Inventors: J. Luke Jenkins, Williamston, SC (US); Robert Andrew Patrick, Simpsonville, SC (US)

(21) Appl. No.: 17/713,921

(22) Filed: Apr. 5, 2022

Related U.S. Application Data
(60) Provisional application No. 63/171,915, filed on Apr. 7, 2021.

(51) Int. Cl. B25H 3/04; B25H 3/00

(52) U.S. Cl. CPC B25H 3/04; B25H 3/006; B25H 3/003

(57) ABSTRACT

A storage system configured includes a support member having a cleat thereon, a bracket engageable with the cleat, and a lever movable between a locked position and an unlocked position. The storage system further includes an object permitted to be coupled or uncoupled relative to the bracket while the lever is in the unlocked position, the object being secured to the bracket while the lever is in the locked position.

### CROSS-REFERENCE TO RELATED APPLICATION

This application claims priority to U.S. Provisional Patent Application No. 63/171,915, filed Apr. 7, 2021, the entire contents of which are incorporated by reference herein.

### TECHNICAL FIELD

The present disclosure relates to storage systems, and more particularly to wall mounted storage systems for tools and the like.

### BACKGROUND

Hand tools, power tools, and associated accessories such as batteries, tool bits, fasteners, and the like, may be moved frequently between a storage space and a work space. One aspect of accessibility is a user's ability to quickly store an object and remove the object from storage. Another aspect of accessibility is the storage system's ability to engage many objects with a standardized connection mechanism between the system and the object. This may also permit an object to engage the storage system at a plurality of locations. Finally, accessible storage systems provide options for accessing tools and bits with tools either directly from the storage system, or from a mobile storage system (i.e., on a tool belt) that is movable with the user between the storage system and a position adjacent a work space.

### SUMMARY

In one independent aspect, a storage system includes a support member having a cleat thereon, a bracket engageable with the cleat, and a lever movable between a locked position and an unlocked position. The storage system further includes an object permitted to be coupled or uncoupled relative to the bracket while the lever is in the unlocked position, the object being secured to the bracket while the lever is in the locked position.

In another independent aspect, a storage system is configured to support a tool. The support system includes a first support member having a cleat thereon, and a bracket. The bracket is configured to engage the cleat. The bracket includes a retainer configured to engage a support surface of a second support member separate from the first support member. The bracket is selectively coupled to the tool. While the bracket is coupled to the tool, the bracket and the tool and movable between a first position, a second position, and a third position. While in the first position, the bracket engages the cleat and supports the tool relative to the cleat. While in the second position, the bracket engages the support surface and supports the tool relative to the support surface. While in the third position, the bracket is removed from the cleat and the support surface.

In yet another independent aspect, a storage system is configured to support a tool. The storage system includes a support member having a cleat thereon and a bracket. The bracket is configured to engage the cleat. The bracket includes a bit storage member including a plurality of recesses each configured to selectively receive one of a plurality of tool bits therein. The bracket further includes a retainer configured to secure the bracket to the tool.

Other aspects of the disclosure will become apparent by consideration of the detailed description and accompanying drawings.

### BRIEF DESCRIPTION OF THE DRAWINGS

FIG. 1 is a front view of a tool storage system including a support member, a bracket, and a tool.

FIG. 2 is an exploded perspective view of the bracket and a portion of the tool of FIG. 1.

FIG. 3 is a perspective view of a portion of the tool of FIG. 1.

FIG. 4 is a front view of a tool storage system including a support member, a tool, and a bracket according to another embodiment.

FIG. 5 is a perspective view of the support member, the tool, and the bracket of FIG. 4.

FIG. 6 is another perspective view of the bracket and the tool of FIG. 4.

FIG. 7 is a perspective view of a tool, a support member, and a bracket according to another embodiment.

FIG. 8 is another perspective view of the tool, the support member, and the bracket of FIG. 7.

FIG. 9 is another perspective view of the tool, the support member, and the bracket of FIG. 7.

### DETAILED DESCRIPTION

Before any aspects are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

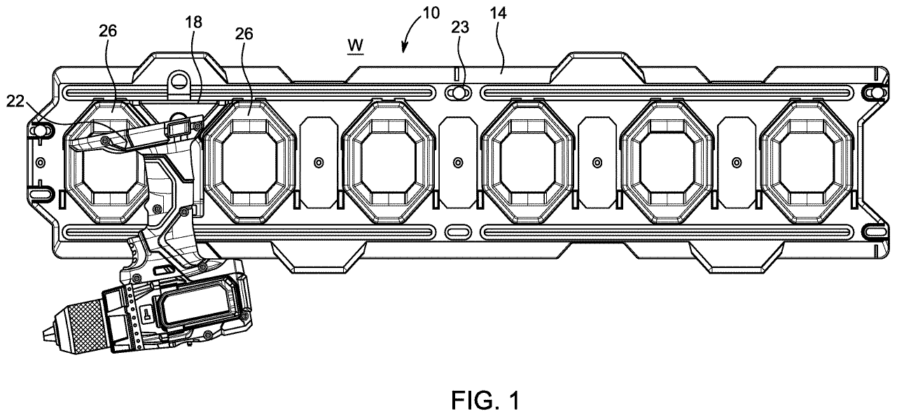

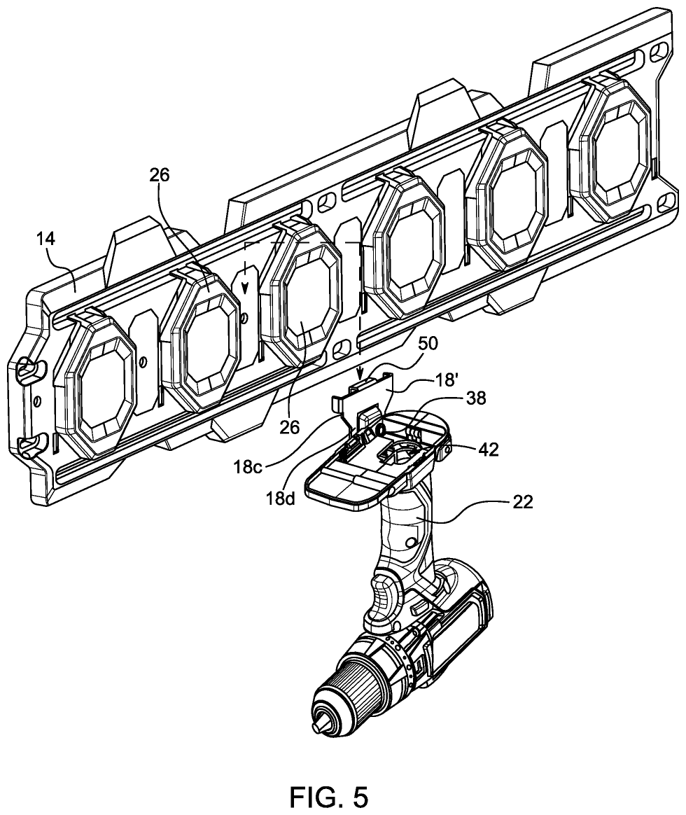

FIG. 1 illustrates a tool storage system 10 including a support member (e.g., a panel or rail 14), a bracket 18, and an object (e.g., a tool, optionally a power tool) 22. The rail 14 is mounted on a wall W (i.e., a support surface) by a support fastener 23 (FIG. 1). The illustrated rail 14 may include multiple projections or cleats 26 which project outwardly from the wall W (see FIG. 5) and protrude from the rail 14. In other embodiments, the rail 14 may include a single cleat 26. In the illustrated embodiment, the bracket 18 of the tool storage system 10 engages (i.e., is nested between) multiple cleats 26 and is supported between adjacent cleats 26. In other embodiments, the bracket 18 may engage the cleats 26 in a different manner, and/or may engage a single cleat 26. The bracket 18 is coupled to the tool 22 for connecting the tool 22 to the rail 14. The rail 14 may support more than a single bracket 18 and tool 22 in a similar manner as described with respect to the illustrated bracket 18 and tool 22.

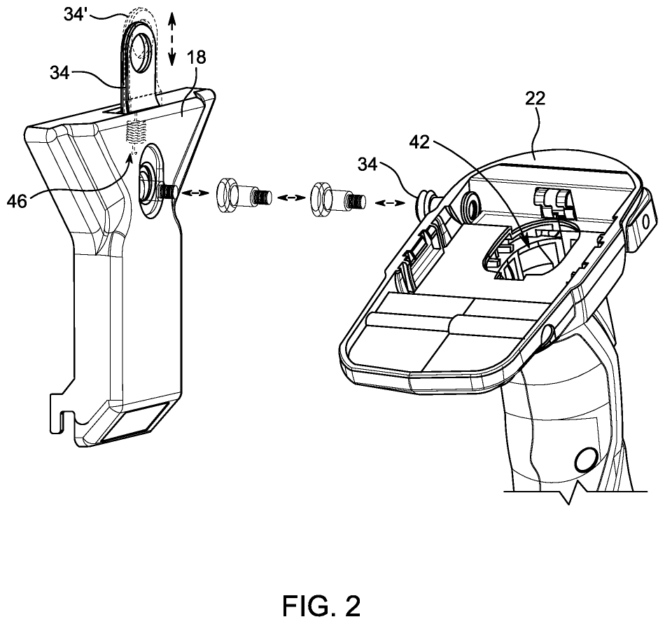

FIG. 2 illustrates a retention mechanism 30 configured to connect the tool 22 to the bracket 18. In the illustrated embodiment, the retention mechanism 30 includes a lever 34 that is supported for movement with respect to the bracket 18. In the illustrated embodiment, the lever 34 is positioned at least partially within a lever receptacle 18a on the bracket 18, and is movable between a locked position (illustrated in solid lines) and an unlocked or released position (illustrated in dashed lines). In some embodiments, the lever 34 may be biased toward the locked position by a biasing force and is movable to the unlocked position in response to a force exerted against the biasing force. In the illustrated embodiment, the retention mechanism 30 provides a quick release retention mechanism 30 in which an operator can quickly secure and/or remove the tool 22 from the bracket 18.

With reference to FIG. 2, the lever 34 is movable between a locked position (illustrated as the lever 34) in which the tool 22 is secured to the bracket 18 and thus the rail 14 and the unlocked position (illustrated as the lever 34′) in which the tool 22 is separable from the bracket 18. In the locked position, the tool 22 is coupled to the bracket 18 by the lever 34. The lever 34′ is translatable between the locked position (illustrated as the lever 34) and the unlocked position (illustrated as the lever 34′). More specifically, as viewed in FIG. 1, the lever 34 is translated in a direction that is perpendicular (i.e., transverse) to the direction in which the cleats 26 project from the rail 14. In the illustrated embodiment, at least a portion of the lever 34 is received in the lever receptacle 18a in both the locked position (lever 34) and the unlocked position (lever 34′).

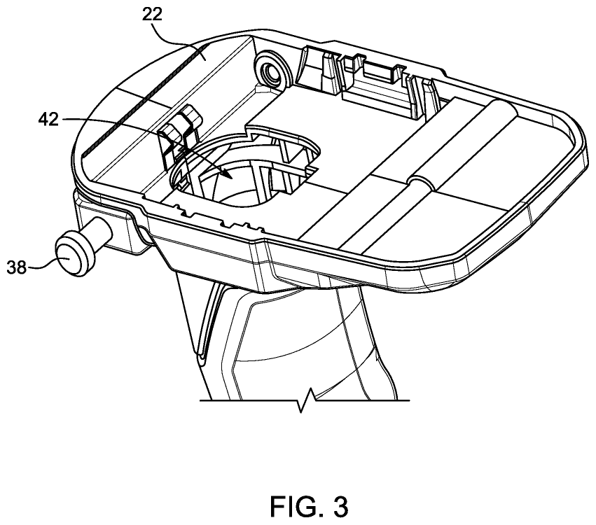

As illustrated in FIGS. 2 and 3, the retention mechanism 30 further includes a stud 38 which is secured to the tool 22. In the illustrated embodiment, the stud 38 is located adjacent a battery receptacle 42 of the tool 22. Further, in the illustrated embodiment, the stud 38 projects laterally away from the battery receptacle 42 of the tool 22. The stud 38 is movable to engage the lever 34 and to provide the force exerted against the biasing force to retract the lever 34 to the unlocked position (illustrated as the lever 34′). Subsequently, the stud 38 is configured to engage the lever 34 to connect the tool 22 the lever 34. The bracket 18 includes an opening 18b. The opening 18b is in communication with the lever receptacle 18a. In the illustrated embodiment, the lever receptacle 18a and the opening 18b are spaces within the bracket 18 and are interconnected. In the locked position, the stud 38 is received within the opening 18b, and the lever 34 is in the locked position (indicated by the lever 34). At least a portion of the tool 22 is movable through the opening 18b and into the lever receptacle 18a within the bracket 18. In the illustrated embodiment, the stud 38 is removably coupled to the tool 22, and the stud 38 functions as an extension of the tool 22 which projects laterally away from the battery receptacle 42. More specifically, the stud 38 functions as an extension of the portion of the tool 22 adjacent the battery receptacle 42. In other embodiments, the tool 22 may directly engage the bracket 18 (e.g., may be received directly within the bracket 18). In this locked position, the stud 38 is supported by the bracket 18. The lever 34 thus inhibits removal of the stud 38 from the opening 18b.

In transitioning to the unlocked position, a user may conduct a “quick release” of the lever 34 to the unlocked position (illustrated as the lever 34′). The stud 38 and thus the tool 22 can then be removed from the bracket 18. Accordingly, the stud 38 can be quickly engaged and disengaged from the bracket 18. Additionally or alternatively, the stud 38 may be used to provide a transition force and to connect the tool 22 to another support surface (e.g., another bracket 18, a belt clip, another storage system 10). The lever 34 may be biased by a spring 44 (shown schematically in FIG. 2) toward the locked position in which the lever 34 secures the stud 38 to the bracket 18. In other embodiments, the lever 34 may be biased and/or held in the locked position or the unlocked position by other means (e.g., a ratcheting mechanism).

To couple the tool 22 to the rail 14, the bracket 18 may be first secured to the rail 14 as illustrated in FIG. 1. As illustrated in FIG. 2, the tool 22 may then be moved to cause the stud 38 to engage the lever 34 of the bracket 18. In the illustrated embodiment, insertion of the stud 38 into a void of the lever 34 causes movement of the lever 34 from the locked position to the unlocked position. Once the stud 38 passes a threshold position through the lever 34, the lever 34 is retracted (by the biasing force of the spring 44) from the unlocked position to the locked position in which the lever 34 secures the tool 22 to the bracket 18, and thus, the rail 14.

To release or uncouple the tool 22 from the rail 14, the tool 22 may be moved in a direction away from the wall W, causing the stud 38 to press on the lever 34 and move the lever 34 from the locked position to the unlocked position. Once the stud 38 passes a threshold position, the lever 34 is returned to the locked position (by the biasing force of the spring 44) and the stud 38 and the tool 22 is removed from the bracket 18. The connecting and releasing operations permit quick coupling and uncoupling of the tool 22 with respect to the rail 14. Further, given the standardized sizes of the cleats 26 and brackets 18, the tool 22 may be quickly moved to engage another bracket 18 in a different location (e.g., adjacent a desired work space).

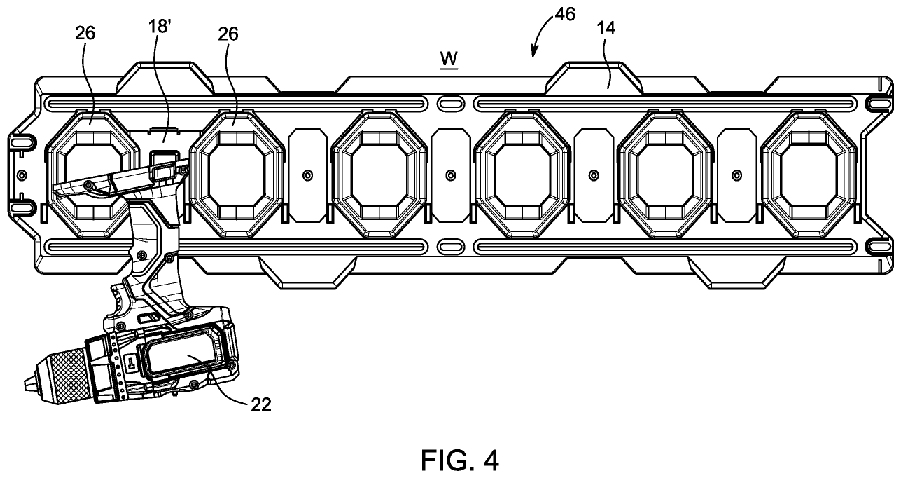

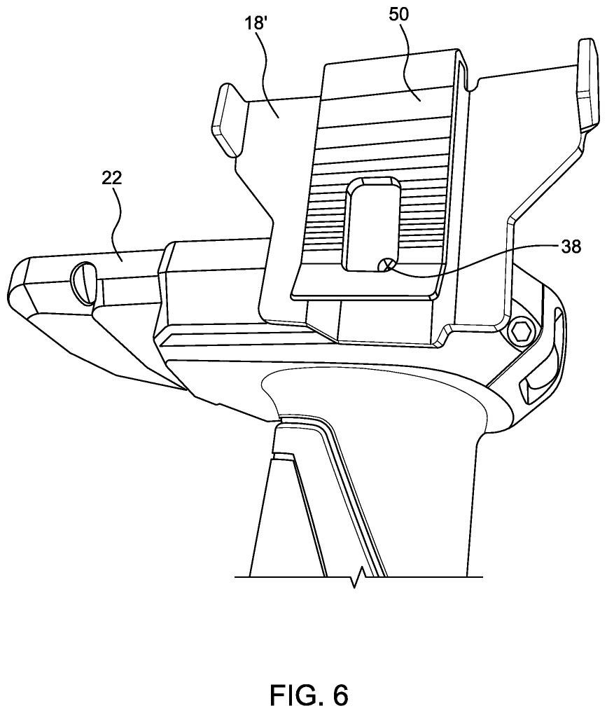

FIGS. 4-6 illustrate a tool storage system 46 in accordance with another embodiment. Features of the tool storage system 46 may be applied in the tool storage system 10, and features of the tool storage system 10 may be applied in the tool storage system 46. As best illustrated in FIG. 6, a bracket 18′ of the tool storage system 46 is secured to the tool 22 by the stud 38. Accordingly, the tool 22 is movable between a first engaged position in which the tool 22 engages the cleat 26 and a second engaged position in which the bracket 18′ engages another support surface (e.g., another bracket, a belt clip, the other storage system 10, etc.) and a third position in which the tool 22 is removed from both the cleat 26 and the other support surface. In the illustrated embodiment, the bracket 18′ is located adjacent the battery receptacle 42 of the tool with the stud 38 projecting laterally away from the battery receptacle 42 of the tool 22. The bracket 18′ is dimensioned to be supported between adjacent cleats 26 of the rail 14. The bracket 18′ may be removed from one set of adjacent cleats 26 (i.e., a first cleat 26 and a second cleat 26) and engaged to another set of adjacent cleats 26 (i.e., the two adjacent cleats at another position on the rail). The bracket 18′ may be dimensioned such that one bracket 18′ may be nested between adjacent cleats 26 of the rail 14. The bracket 18′ may be otherwise dimensioned such that one bracket 18′ may engage a single cleat 26 of the rail 14. Further, the bracket 18′ provides a quick release retention mechanism 30 which permits quick release of the tool 22 from the rail 14 by movement of the bracket 18′ away from the adjacent cleats 26.

As best illustrated in FIG. 6, the bracket 18′ further includes a retainer 50. In the illustrated embodiment, the retainer 50 is formed as a cantilevered hook. The periphery of the bracket 18′ includes a wing tip 18c formed at a distal end of the bracket 18′. The wing tip 18c provides an engagement surface of the bracket 18′ which is engageable and removable from adjacent cleats 26 of the rail 14. The wing tip 18c extends laterally away from a body portion 18d of the bracket 18′. Other engagement surfaces are possible. The retainer 50 extends from the body portion 18d. When the bracket 18′ is in the first position (engaged with the cleat 26 as in FIG. 4), the retainer 50 (i.e., the cantilevered hook) extends from the bracket 18′ in a direction towards the rail 14 (i.e., into the page as viewed in FIG. 4). Once the bracket 18′ is removed from the rail 14, the retainer 50 of the bracket 18′ is attachable to another support surface (e.g., a belt clip, a different tool storage component, a vehicle mounted storage system, etc.), which may be separate from the rail 14. The bracket 18′ includes an engagement surface (provided by the periphery of the bracket 18′) which is operable to attach the bracket 18′ to the rail 14. Further, the bracket 18′ includes a retainer 50 which is operable to attach the bracket 18′ to another support surface. In the illustrated embodiment, the periphery of the bracket 18′ is configured (i.e., dimensioned and toleranced) to removably engage (i.e., nest between) adjacent cleats 26 of the rail 14, and the retainer 50 is configured (i.e., dimensioned and toleranced) to removably engage a belt clip. With the tool storage system 46, a user is capable of removing the bracket 18′ and the tool 22 from the rail 14, attaching the tool 22 to the user's belt, and moving from the rail 14 to a work space while having access to but not directly holding the tool 22.

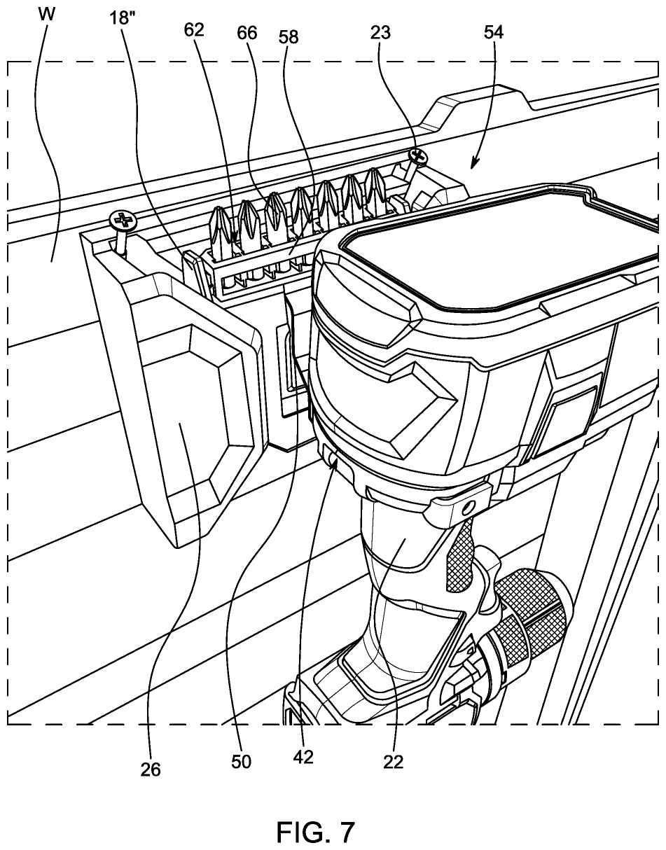

FIGS. 7-9 illustrate a tool storage system 54 in accordance with another embodiment. Features of the tool storage system 54 may be applied in the tool storage system 10 and/or the tool storage system 46, and features of the tool storage systems 10, 46 may be applied in the tool storage system 54.

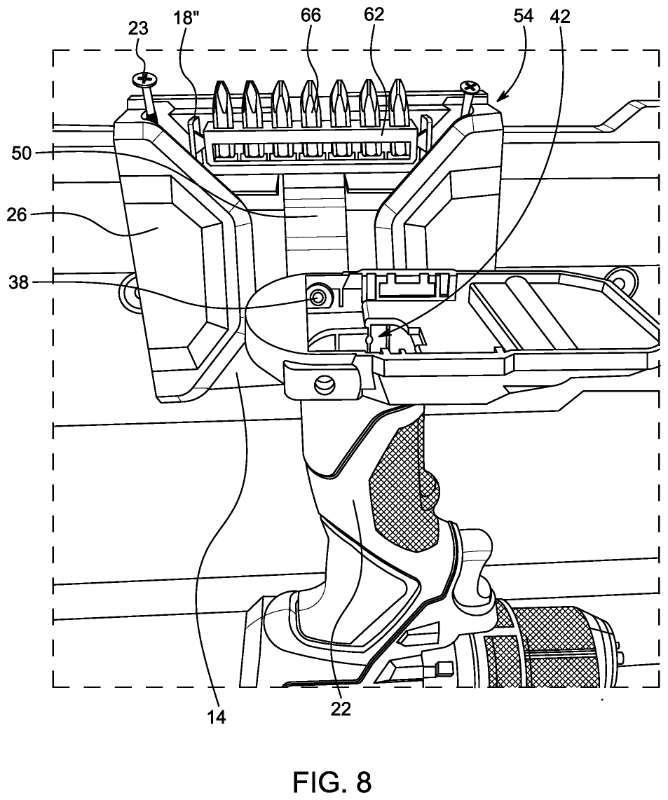

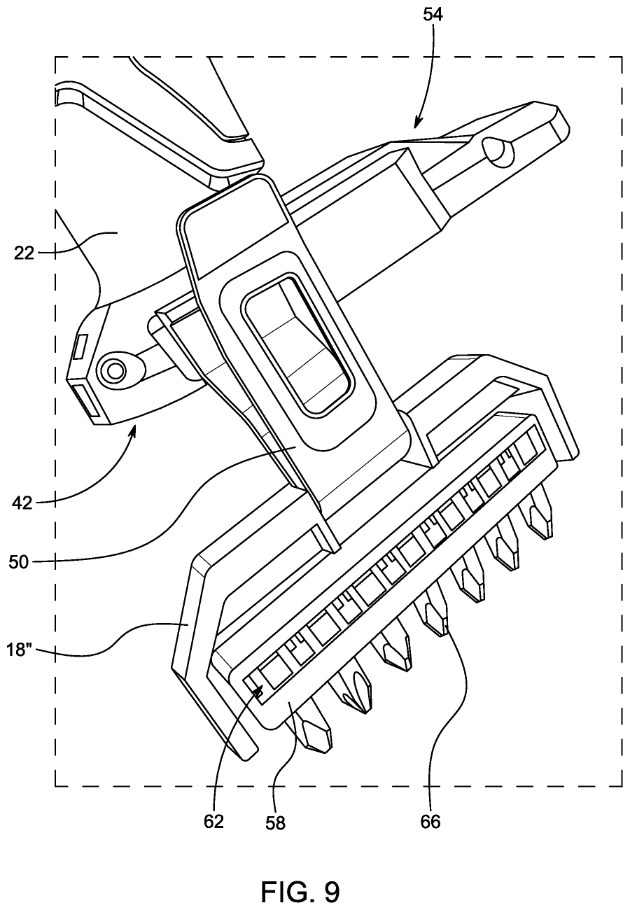

As best illustrated in FIG. 7, the tool storage system 54 includes a bracket 18″ which holds a bit bar (i.e., a bar, a bit storage member) 58. The bit bar 58 may be removably coupled to the bracket 18″. The bit bar 58 may be pivotable relative to the bracket 18″. The bit bar 58 includes recesses 62 which are dimensioned to removably receive bits (i.e., tool bits) 66 for use with the tool 22. As best illustrated in FIGS. 8 and 9, the bracket 18″ further includes a retainer 50 similar to the retainer 50 of the bracket 18′. The bracket 18″ is provided with an engagement surface (provided by the periphery of the bracket 18″) which is operable to attach the bracket 18″ to the rail 14. Further, the bracket 18″ includes the retainer 50 which is operable to attach the bracket 18″ to another support surface (e.g., another bracket, a belt clip, the other storage system 10, etc.), which may be separate from the rail 14. In the illustrated embodiment, the periphery of the bracket 18″ is configured (i.e., dimensioned and toleranced) to removably engage (i.e., nest between) adjacent cleats 26 of the rail 14, and the retainer 50 is configured (i.e., dimensioned and toleranced) to removably engage a belt clip. The bit bar 58 is configured (i.e., dimensioned and toleranced) to removably engage the bracket 18″. The bits 66 are configured (i.e., dimensioned and toleranced) to removable engage the recesses 62. The bits 66 may be selectively coupled to the recesses 62, (and thus coupled to the bit bar 58 and the bracket 18″) independently of whether the bracket 18″ is secured to the cleat(s) 26 and the rail 14. Accordingly, a user can remove the tool 22 with the bracket 18″ attached thereto, transport the tool 22 and the bracket 18″ to a position away from the rail 14, and selectively remove the bit 66 or a plurality of bits 66 from their corresponding recesses 62 at the position away from the rail 14.

Although aspects of the disclosure have been described in detail with reference to certain preferred embodiments, variations and modifications exist within the scope and spirit of one or more independent aspects as described. One or more independent features and/or advantages may be set forth in the following claims.

What is claimed is:

1. A storage system comprising:
a support member having a cleat thereon;
a bracket engageable with the cleat;
a lever movable between a locked position and an unlocked position; and
an object being permitted to be coupled or uncoupled relative to the bracket while the lever is in the unlocked position, the object being secured to the bracket while the lever is in the locked position.

2. The storage system of claim 1, further comprising a spring biasing the lever toward the locked position.

3. The storage system of claim 1, wherein the support member has a plurality of cleats, and the bracket is configured to engage at least two cleats of the plurality of cleats.

4. The storage system of claim 1, wherein the bracket includes an opening in communication with a lever receptacle, the lever receptacle, and at least a portion of the object is movable through the opening and into the lever receptacle.

5. The storage system of claim 4, wherein the object is a power tool including a battery receptacle, and the portion of the object is a stud that is removably coupled to the object and projects laterally away from the battery receptacle.

6. The storage system of claim 1, wherein the lever is translatable between the locked position and the unlocked position, the lever translated in a direction transverse to the extension of the cleat from the support member.

7. A storage system configured to support a tool, the storage system comprising:
a first support member having a cleat thereon;
a bracket configured to engage the cleat, the bracket including a retainer configured to engage a support surface of a second support member separate from the first support member, the bracket selectively coupled to the tool, while the bracket is coupled to the tool, the bracket and the tool are movable between a first position, a second position, and a third position,
while in the first position, the bracket engages the cleat and supports the tool relative to the cleat,
while in the second position, the bracket engages the support surface and supports the tool relative to the support surface, and
while in the third position the bracket is removed from the cleat and the support surface.

8. The storage system of claim 7, wherein the first support member further includes a second cleat thereon, wherein in the first position, the bracket is configured to engage the cleat and the second cleat.

9. The storage system of claim 8, wherein the support member further includes a third cleat thereon, wherein in a fourth position, the bracket is configured to engage the cleat and the third cleat.

10. The storage system of claim 7, wherein the bracket includes a body portion and a wing extending laterally away from the body portion, the wing engageable with the cleat while the bracket and the tool are in the first position.

11. The storage system of claim 10, wherein the bracket further includes a wing tip positioned at a distal end of the wing spaced from the body portion, the wing tip engageable with the cleat while the bracket and the tool are in the first position.

12. The storage system of claim 7, wherein the bracket includes a body portion and a retainer, the retainer being formed as a cantilevered hook extending from the body portion.

13. The storage system of claim 12, wherein while the bracket is coupled to the tool and positioned in the first position, the cantilevered hook extends from the bracket in a direction towards the first support member.

14. The storage system of claim 7, further comprising a stud coupling the object to the bracket.

15. The storage system of claim 14, wherein the object is a power tool including a battery receptacle and the stud projects laterally away from the battery receptacle.

16. A storage system configured to support a tool, the storage system comprising:
a support member having a cleat thereon;
a bracket configured to engage the cleat, the bracket including
bit storage member including a plurality of recesses, each of the recesses configured to selectively receive one of a plurality of tool bits therein, and
a retainer configured to secure the bracket to the tool.

17. The storage system of claim 16, wherein the retainer is configured to engage a support surface of a second support member separate from the support member.

18. The storage system of claim 16, wherein selective receipt of each tool bit with the bit storage member is independent of whether the bracket is engaged with the cleat.

19. The storage system of claim 16, wherein while the bracket is secured to the tool by the retainer, the bracket and the tool are movable between a first position in which the bracket engages cleat and the bracket supports the tool relative to the cleat, a second position in which the bracket engages a support surface of a second support member separate from the support member and supports the tool relative to the support surface, and a third position in which the bracket is removed from the cleat and the support surface.

20. The storage system of claim 16, wherein the bit storage member is removably coupled to the bracket.
